(19) United States
(12) Patent Application Publication
(10) Pub. No.: US 2026/0333478 A1
(43) Pub. Date: Oct. 22, 2026

(54) SIDELINK ACTIVATION FOR COVERAGE CONTINUITY IN WIRELESS SYSTEMS

(71) Applicant: InterDigital Patent Holdings, Inc., Wilmington, DE (US)

(72) Inventors: Filipe Conceicao, London (GB); Magurawalage Chathura Madhusanka Sarathchandra, London (GB); Alain Mourad, Ascot (GB)

(73) Assignee: InterDigital Patent Holdings, Inc., Wilmington, DE (US)

(21) Appl. No.: 19/116,873

(22) PCT Filed: Sep. 29, 2023
(86) PCT No.: PCT/US2023/034176

§ 371 Date: Mar. 28, 2025

Related U.S. Application Data
(60) Provisional application No. 63/412,131, filed on Sep. 30, 2022.

(51) Int. Cl. H04W 76/14; H04B 17/309; H04W 92/18

(52) U.S. Cl. CPC H04W 76/14; H04B 17/309; H04W 92/18

(57) ABSTRACT

Systems, methods, and instrumentalities are described herein for sidelink activation for coverage continuity in wireless systems. A wireless transmit/receive unit (WTRU) (e.g., second WTRU) may be configured to receive, from a network (e.g., network node or base station), a trajectory prediction of the second WTRU. The second WTRU may send, to the network, feedback associated with the trajectory prediction of the second WTRU. The second WTRU may receive, from the network, an activation indication to activate sidelink communication with a first WTRU with the activation window. The second WTRU may communicate with the first WTRU via a sidelink connection with the activation window. The second WTRU may send, to the network, a feedback report associated with the sidelink communication with the first WTRU within the activation window.

### CROSS-REFERENCE TO RELATED APPLICATIONS

This application claims the benefit of Provisional U.S. Patent Application No. 63/412,131, filed Sep. 30, 2022, the disclosure of which is incorporated herein by reference in its entirety.

### BACKGROUND

In wireless communication networks, sub-optimal coverage conditions and/or events may occur and/or persist. For example, a device may fail to communicate with a network because signal levels are not sufficient to access the Physical Downlink Control Channel of any cell (e.g., the device may be in coverage hole or otherwise unable to communicate with the network). If a device cannot be served by any cell, sidelink communication can occur.

### SUMMARY

Systems, methods, and instrumentalities are described herein for sidelink activation for coverage continuity in wireless systems.

A wireless transmit/receive unit (WTRU) (e.g., second WTRU) may be configured to receive, from a network (e.g., network node or base station), a trajectory prediction of the second WTRU. The second WTRU may send, to the network, feedback associated with the trajectory prediction of the second WTRU. In examples, an activation window may be determined based on the feedback associated with the trajectory prediction of the second WTRU. The second WTRU may receive, from the network, an activation indication to activate sidelink communication with a first WTRU with the activation window. In examples, the indication to activate sidelink communication with the first WTRU within the activation window may include an indication of an identifier (ID) associated with the first WTRU. In examples, the activation window may be a timing window defined by starting and ending timestamps. In examples, the activation window may be a geo-location area.

The second WTRU may communicate with the first WTRU via a sidelink connection with the activation window. The second WTRU may send, to the network, a feedback report associated with the sidelink communication with the first WTRU within the activation window. In examples, the feedback report may include one of more of: a measure of uplink (UL) data received from a connected WTRU, a measure of downlink (DL) data sent to a connected WTRU, information related to quality of service, or information related to quality of experience. In examples, the feedback report may indicate a radio quality associated with the sidelink communication with the first WTRU within the activation window. The radio quality may be indicated by a reference signal received power (RSRP) value, a reference signal received quality (RSRQ) value, or a signal to noise and interference ratio (SINR) value.

A base station (e.g., a network node or network) may be configured to determine that a radio resource condition is satisfied for an area associated with the base station. In examples, the determination that the radio resource condition is satisfied may be based on measurement reporting from one or more WTRUs. The measurement reporting may indicate that a radio quality associated with the area is below a threshold. The radio quality associated with the area being below the threshold may be determined based on a reference signal received power (RSRP) value, a reference signal received quality (RSRQ) value, or a signal to noise and interference ratio (SINR) value.

The base station may predict a trajectory of a first WTRU and a trajectory of a second WTRU. The base station may send an initial trajectory prediction of the first WTRU to the first WTRU and an initial trajectory prediction of the second WTRU to the second WTRU. The base station may receive feedback from the first WTRU associated with the initial trajectory prediction of the first WTRU and from the second WTRU associated with the initial trajectory prediction of the second WTRU. The predicted trajectory of the first WTRU may be based on the initial trajectory prediction of the first WTRU and the feedback from the first WTRU, and the predicted trajectory of the second WTRU may be based on the initial trajectory prediction of the second WTRU and the feedback from the second WTRU. The trajectory of the first WTRU may indicate that the first WTRU will enter an area.

The base station may determine that a proximity condition associated with the second WTRU is satisfied at least based on the predicted trajectory of the second WTRU. In examples, the base station may determinate that the proximity condition associated with the second WTRU is satisfied further based on the predicted trajectory of the first WTRU. Based on the predicted trajectories, the base station may determine an activation window. In examples, the activation window may be a timing window defined by starting and ending timestamps or may be a geo-location area. The base station may send an activation indication to the second WTRU to activate sidelink communication with the first WTRU. The activation indication may be associated with the activation window. The base station may receive, from the second WTRU, a feedback report associated with a sidelink communication within the activation window.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example NG-RAN architecture with support for an example PC5 interface;

FIG. 3A is a message flow diagram illustrating an example RRC reconfiguration procedure between an example WTRU and an example network;

FIG. 3B is an example sidelink information element of an example RRCReconfiguration message;

FIG. 4 is a path diagram illustrating two example WTRUs passing encountering a sub-optimal coverage area (e.g. a coverage hole);

FIG. 5 is a path diagram illustrating an example sidelink scenario involving two example WTRUs;

FIG. 6 is a path diagram illustrating an example scenario including sidelink activation for coverage continuity;

FIG. 7 is a path diagram including a timeline of events illustrating an example scenario involving including sidelink activation for coverage continuity;

FIG. 8 is a message flow diagram illustrating an exemplary procedure including (pre-)configuration, activation, and behavior of a WTRU providing sidelink coverage.

### DETAILED DESCRIPTION

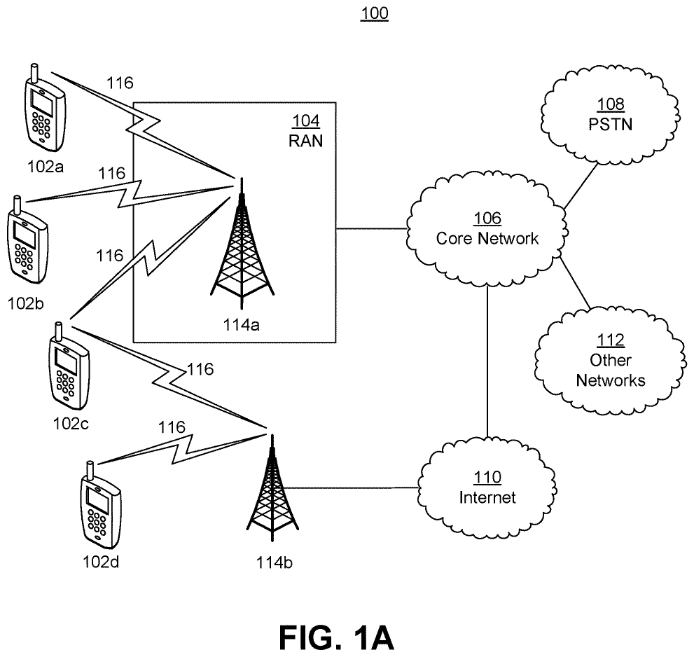

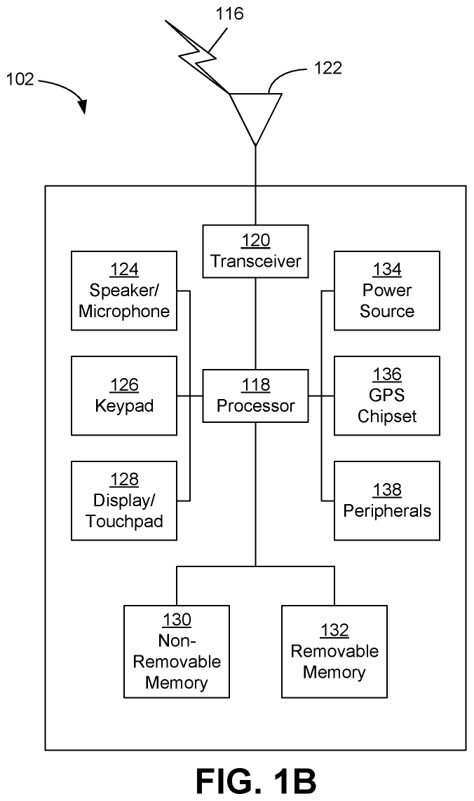

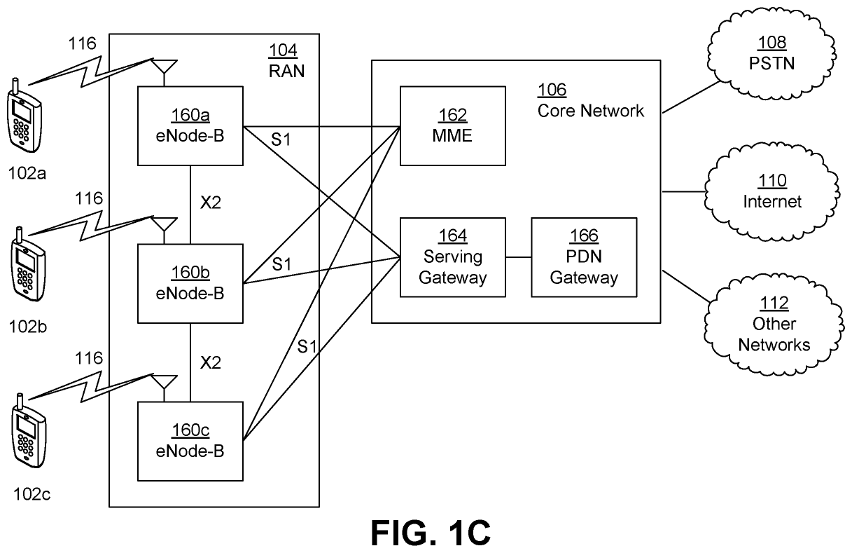

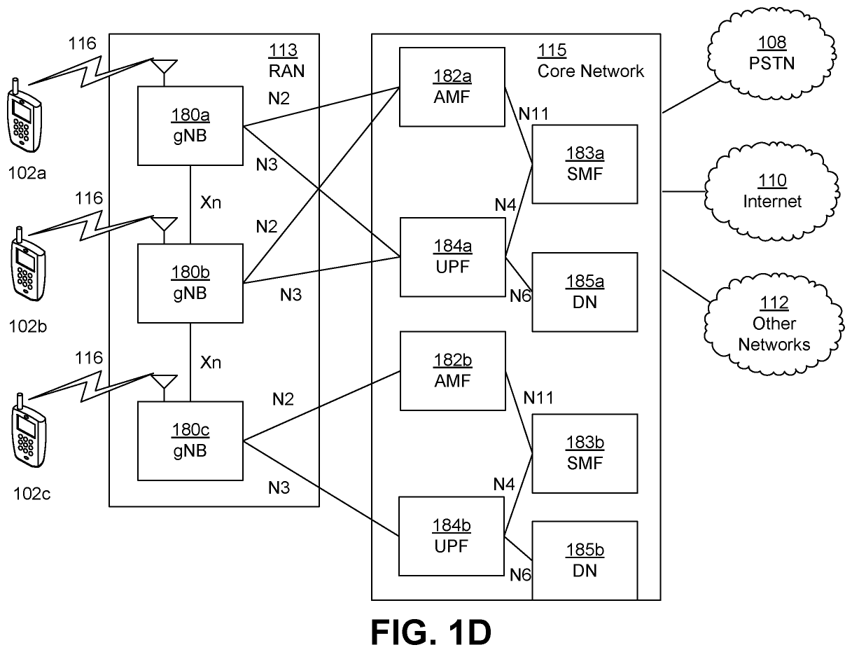

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QOS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a legacy technology or legacy handover, may indicate a legacy technology such as LTE compared to NR, or, a legacy version of a technology, for example an earlier version/release of a technology (e.g., earlier NR release) compared to a later version/release of the technology (e.g., later NR release).

Systems, methods, and instrumentalities are described herein for sidelink activation for coverage continuity in wireless systems.

A wireless transmit/receive unit (WTRU) (e.g., second WTRU) may be configured to receive, from a network (e.g., network node or base station), a trajectory prediction of the second WTRU. The second WTRU may send, to the network, feedback associated with the trajectory prediction of the second WTRU. In examples, an activation window may be determined based on the feedback associated with the trajectory prediction of the second WTRU. The second WTRU may receive, from the network, an activation indication to activate sidelink communication with a first WTRU with the activation window. In examples, the indication to activate sidelink communication with the first WTRU within the activation window may include an indication of an identifier (ID) associated with the first WTRU. In examples, the activation window may be a timing window defined by starting and ending timestamps. In examples, the activation window may be a geo-location area.

The second WTRU may communicate with the first WTRU via a sidelink connection with the activation window. The second WTRU may send, to the network, a feedback report associated with the sidelink communication with the first WTRU within the activation window. In examples, the feedback report may include one of more of: a measure of uplink (UL) data received from a connected WTRU, a measure of downlink (DL) data sent to a connected WTRU, information related to quality of service, or information related to quality of experience. In examples, the feedback report may indicate a radio quality associated with the sidelink communication with the first WTRU within the activation window. The radio quality may be indicated by a reference signal received power (RSRP) value, a reference signal received quality (RSRQ) value, or a signal to noise and interference ratio (SINR) value.

A base station (e.g., a network node or network) may be configured to determine that a radio resource condition is satisfied for an area associated with the base station. In examples, the determination that the radio resource condition is satisfied may be based on measurement reporting from one or more WTRUs. The measurement reporting may indicate that a radio quality associated with the area is below a threshold. The radio quality associated with the area being below the threshold may be determined based on a reference signal received power (RSRP) value, a reference signal received quality (RSRQ) value, or a signal to noise and interference ratio (SINR) value.

The base station may predict a trajectory of a first WTRU and a trajectory of a second WTRU. The base station may send an initial trajectory prediction of the first WTRU to the first WTRU and an initial trajectory prediction of the second WTRU to the second WTRU. The base station may receive feedback from the first WTRU associated with the initial trajectory prediction of the first WTRU and from the second WTRU associated with the initial trajectory prediction of the second WTRU. The predicted trajectory of the first WTRU may be based on the initial trajectory prediction of the first WTRU and the feedback from the first WTRU, and the predicted trajectory of the second WTRU may be based on the initial trajectory prediction of the second WTRU and the feedback from the second WTRU. The trajectory of the first WTRU may indicate that the first WTRU will enter an area.

The base station may determine that a proximity condition associated with the second WTRU is satisfied at least based on the predicted trajectory of the second WTRU. In examples, the base station may determinate that the proximity condition associated with the second WTRU is satisfied further based on the predicted trajectory of the first WTRU. Based on the predicted trajectories, the base station may determine an activation window. In examples, the activation window may be a timing window defined by starting and ending timestamps or may be a geo-location area. The base station may send an activation indication to the second WTRU to activate sidelink communication with the first WTRU. The activation indication may be associated with the activation window. The base station may receive, from the second WTRU, a feedback report associated with a sidelink communication within the activation window.

A WTRU may be configured by a network for sidelink communication and may (e.g., may then) assist another WTRU facing sub-optimal coverage problems. The WTRU may trigger sidelink information broadcasting that other WTRUs may connect to as a continuity resource available to avoid service disruption.

In examples, a first WTRU may be configured by a sidelink broadcast activation message, which message may be based on network-predicted WTRU radio conditions and/or trajectories (e.g. based on artificial intelligence or machine learning models). For example, the sidelink broadcast activation message may include configuration information. For example, the configuration information may include radio condition information and/or trajectory information. For example, such configuration and/or configuration information may include and/or persist for a duration. The WTRU may evaluate the configuration information against measurements of radio conditions and/or trajectories and may trigger advertisement of sidelink resources. In examples, the configuration information may represent one or more conditions upon which the WTRU may broadcast availability of sidelink resources. For example, the configuration information may include conditions related to radio conditions and/or trajectories, the satisfaction of which may trigger advertisement of sidelink resources. A second WTRU may connect to the first WTRU for a period up to the duration (if any).

In examples, a first WTRU may be configured by an immediate sidelink broadcast activation message. The message may be based on network-predicted WTRU radio conditions and/or trajectories (e.g. based on artificial intelligence or machine learning models). The (pre-)configuration may persist for a duration. The WTRU may advertise for sidelink resources available. A second WTRU may connect to the first WTRU for a period up to the duration (if any).

A WTRU may report feedback information regarding predicted radio conditions and/or trajectories provided by the network. The feedback information may be triggered by a network (pre-)configuration during, in some examples, as defined within a duration.

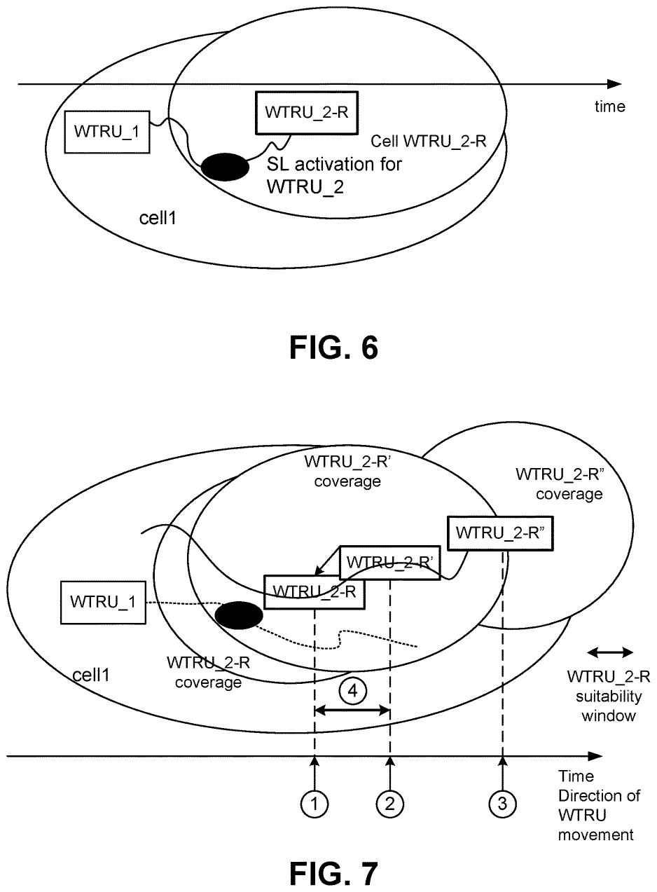

Examples of measurement reporting techniques in wireless communication systems are provided herein. Such measurement reporting techniques discussed below may be used if reporting in connection with sidelink activation. For example, such measurement reporting techniques discussed below may be used in connection with WTRU feedback reporting. For example, measurement reporting techniques discussed below may be used to report measurements, such as those disclosed in connection with FIG. 6 below (e.g., reporting in connection with suboptimal coverage).

Measurement reporting may be periodical. For periodical reports, a WTRU may be configured with a value from a set such as {ms 120 (e.g. 120-millisecond periodicity), ms 240, ms 480, ms 640, ms 1024, ms2048, ms5120, ms10240, ms20480, ms40960, min1 (e.g. 1-minute periodicity), min6, min12, min30} and may send reports to a network with the configured periodicity. Measurement reporting may be event-triggered. For event-triggered reports, a WTRU may be configured with measurement criteria that may trigger generation of measurement reports. The event-triggered reports may (e.g., may also) be reported periodically (e.g., also based on a configured periodicity), in some examples, for as long as the criteria remain satisfied.

For event-triggered reports, measurement thresholds may be configured at a WTRU for comparison with measured results by the WTRU. If measurement results exceed the thresholds, a measurement report may be generated by the WTRU and sent to the network. Example events used herein are provided: event A1 (serving cell condition becomes better than threshold); event A2 (serving cell condition becomes worse than threshold); event A3 (neighbor cell condition becomes offset better than SpCell condition); event A4 (neighbor cell condition becomes better than threshold); event A5 (SpCell condition becomes worse than threshold 1 and neighbor cell condition becomes better than threshold 1); event A6 (neighbor cell condition becomes offset better than SCell); event B1 (inter RAT Neighbor cell condition becomes better than threshold); event B2 (PCell becomes worse than threshold1 and inter RAT Neighbor cell condition becomes better tha threshold1); event I1 (interference becomes higher than threshold); event C1 (NR sidelink channel busy ratio is above a threshold); and event C2 (NR sidelink channel busy ratio is below a threshold).

Examples of coverage holes and weak coverage areas are provided herein. A WTRU may experience a coverage hole and/or a weak coverage spot.

A coverage hole may include an area where signal level (e.g. signal to noise ratio (SNR) or signal to noise and interference ratio (SINR)) of both serving and allowed neighbor cells is below a level associated with maintaining basic service (e.g. over sidelink signaling radio bearer (SRB) and/or DL common channels, including basic service such as coverage of physical downlink control channel (PDCCH)). A coverage hole may be caused by physical obstructions such as buildings, hills, by unsuitable antenna parameters, by inadequate ratio front end (RF) planning, etc. A WTRU in a coverage hole may suffer from call drop and/or radio link failure. An example multi-band and/or multi-RAT WTRU may go to another network layer instead.

As used herein, weak coverage occurs if a signal level (e.g. SNR or SINR) of a serving cell is below a level needed to maintain a planned performance requirement (e.g., cell edge bit-rate).

One implication of a coverage hole is that a WTRU may not have enough radio signal exposure from any cell (e.g. a serving cell, a neighbor cell, etc.). One implication of weak coverage is that the SNR of a serving cell may be low enough to cause service performance degradation, but may not be low enough to result in a radio link failure (RLF) (and, e.g., a consequent service interruption).

In areas where coverage of different cells overlap, cell performance may be low because of one or a combination of high interference levels, high power levels, and/or high energy consumption. Such a “pilot pollution” problem may be addressed by reducing coverage of cells. Under a pilot pollution condition, a WTRU may experience high SNR to more than one cell and/or high interference levels.

Overshoot coverage may occur if coverage of a cell reaches far beyond a plan. Overshoot may occur as an island of coverage in the interior of another cell in which the cell may not be a direct neighbor. Overshoot may be caused by reflections in buildings, across open water (e.g. lakes), etc. A WTRU in an overshoot area may suffer call drops and/or high interference. Overshoot coverage may be mitigated by changing coverage of certain cells and/or by mobility blacklisting one or more cells.

Coverage mapping (e.g. information about signal levels in one or more cell areas) may enable assessment and/or prediction of signal levels that can be provided in a network. Coverage mapping may be generated by accumulation of one or more measurements collected in various parts of the network. Coverage mapping accuracy may be enhanced by including measurements collected not just in areas of potential coverage issues.

Poor UL coverage may degrade user experience in terms of call setup failure, call drop, poor UL voice quality, and/or other issues. Coverage may be balanced between uplink and downlink connections. Possible UL coverage optimization may include adapting cellular coverage by, for example, changing the site configuration (e.g. antennas) and/or by adjusting UL related parameters (e.g. to enable optimized usage of UL power in different environments).

Poor handover performance may be caused by cell boundaries changing due to changes in physical condition of a surrounding area (e.g., construction of structures near a handover area). Cell boundary mapping (e.g., information related to location of intra-RAT and/or inter-RAT cell boundaries) may enable comparison of an expected network setting to a measured network setting.

A pico cell may be deployed in area (e.g. a high traffic area). Pico coverage mapping may include information corresponding to whether deployment of a pico cell accords with network needs (e.g. of capacity increase), which may be determined based on a location where a pico cell may be available as an SCell.

Pilot pollution and UL coverage relate to poor service performance due to radio coverage, parameter mis-planning, and/or to high interference levels between cells. Pilot pollution and UL coverage may be forms of weak coverage.

Overshoot coverage, coverage mapping, cell boundary mapping, and pico coverage mapping present problems that may be addressed with NG-RAN nodes and/or by RAN in general understanding the radio coverage of its cells.

Sidelink may be a mechanism whereby more than one WTRUs may engage in direct communication with each other.

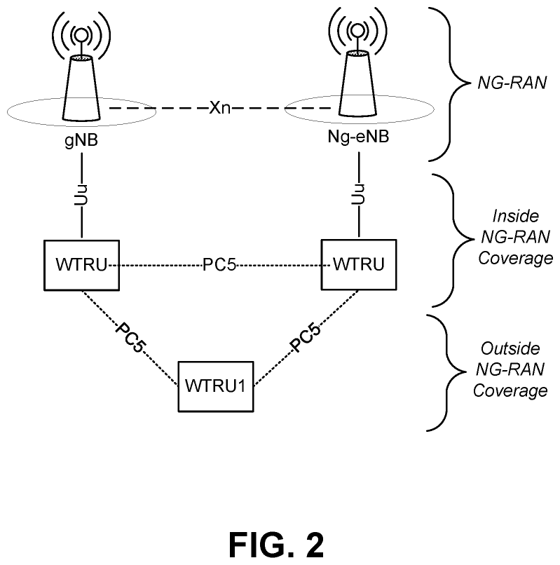

FIG. 2 illustrates NG-RAN architecture support for a an example PC5 interface. As shown in FIG. 2, sidelink transmission and reception over the PC5 interface may be supported if a WTRU (WTRU1) is inside NG-RAN coverage (e.g. in any RRC state) and sidelink transmission may be supported if the WTRU is outside NG-RAN coverage.

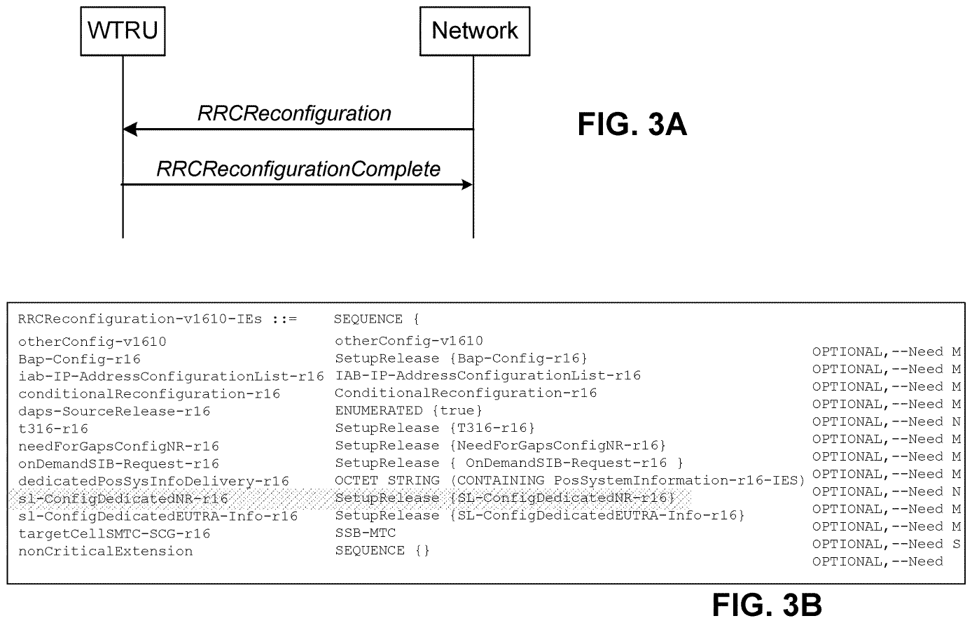

Sidelink may be activated via radio resource control (RRC) messaging. A network may send an RRC message including sidelink configuration information. FIG. 3A illustrates an example RRC reconfiguration procedure. As shown in FIG. 3A, an example network may communicate an RRCReconfiguration message and an example WTRU may communicate an RRCReconfiguration Complete message. FIG. 3B provides an example sidelink information element of an example RRCReconfiguration message.

In examples herein, “activation window” and “suitability window” may be used interchangeably.

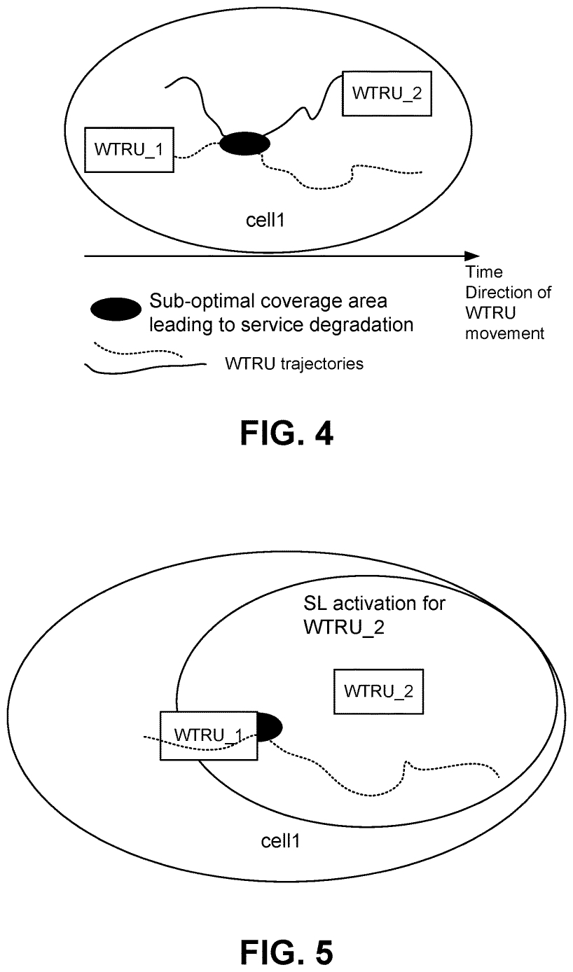

FIG. 4 is a path diagram illustrating two WTRUs encountering a sub-optimal coverage area (e.g. a coverage hole). In a cell featuring at least one coverage hole, a network may be unable to provide sufficient coverage (e.g., satisfying a radio resource condition, for example a measurement below a threshold, for an area associated with the network). One or more WTRUs that pass through the coverage hole may experience service degradation (e.g., as shown in FIG. 4). As shown in FIG. 4, WTRU_1 and WTRU_2 each pass through the sub-optimal coverage area (e.g. a coverage hole) and may each experience service degradation. As shown in FIG. 4, cell1 includes a cell boundary as an oval perimeter and includes a coverage hole as a solid black oval within the cell boundary. The top trajectory line depicts a path through time of an example WTRU, WTRU_2. The bottom trajectory line depicts a path through time of an example WTRU, WTRU_1. Each of WTRU_1 and WTRU_2 travel its trajectory path and intersects the coverage hole. As shown in FIG. 4, WTRU_2 has already passed through the coverage hole (and may have experienced service degradation) and WTRU_1 is on a path to encounter the coverage hole and may experience service degradation.

The network may determine that a radio resource condition is satisfied for an area. In examples (e.g., as shown in FIG. 4), a WTRU may be in mobility in an area where there is no coverage available from another cell. In examples, a WTRU may be in mobility in an area where there is another cell available, but the network may determine the other cell (e.g., neighbor cell) is not able to provide radio resources or the coverage of the other cell (e.g., neighbor cell) is insufficient (e.g. because of admission control at a target RAN node). In such situations of WTRU mobility, sidelink may provide coverage continuity.

In examples discussed herein, sidelink activation (e.g., temporary sidelink activation used as an example herein) may be based on at least air interface measurements (e.g., based on the measurements indicating that a radio resource condition as discussed herein is satisfied). Air interface measurements may include reference signal received power (RSRP) measurements. Air interface measurements may include (e.g., or be entirely) other measurements such as at least one of: reference signal received quality (RSRQ) measurements, signal to noise and interference ratio (SINR) measurements, or others. If the measurement(s) are below a threshold (e.g., where being below a threshold satisfies a weak coverage condition), the measurement(s) may indicate that the radio resource condition (e.g., as described herein) is satisfied.

Examples for providing temporary activation of sidelink communication are provided herein. A WTRU in the vicinity of a sub-optimal coverage area may be instructed to activate sidelink communications (e.g. providing temporary coverage assistance to one or more other WTRUs), and may relay traffic to and from a network.

WTRU trajectory may be predicted using various means (e.g. artificial intelligence and/or machine learning models). Link budget and/or signal strength may predicted and may be associated with a WTRU trajectory. In examples, predictions may be determined at a network level (e.g. at a network radio node). In examples, predictions may be determined at a WTRU level.

FIG. 5 is a path diagram illustrating an example sidelink scenario involving two example WTRUs. As shown in FIG. 5, WTRU_2 may advertise and/or provide sidelink coverage. A WTRU_1 trajectory path may intersect with a coverage hole associated with cell1. FIG. 5 depicts an example scenario in which a WTRU_2 may have initiated sidelink broadcasting of services. FIG. 5 depicts two coverage areas: a cell1 boundary illustrated by the larger oval outline and a WTRU_2 SL boundary illustrated by the smaller oval outline.

Sidelink communication may have a limited range, including in examples involving line of sight connectivity. For examples involving more than one WTRU available for sidelink activation, a WTRU may be selected for sidelink activation, including related aspects such as example parametrization related to activation, duration of an activation procedure, configured grants, etc.

FIG. 6 depicts an example of sidelink activation for coverage continuity. An example network (e.g., a network node, such as a base station) may detect a sub-optimal coverage problem (e.g., by receiving an indication from a WTRU and/or determining that measurement(s) satisfy a radio resource condition for an area associated with the network, for example, the measurement(s) being below a threshold). In examples, the network may detect the problem by receiving a message from an example WTRU that has experienced a problem (e.g., the message may be triggered via configured measurement thresholds for measurement report triggering). The network may (e.g., may then) prepare to take action anticipating recurrence of the problem involving the WTRU or other example WTRUs. In examples, the network may detect the problem by consulting a RAN database. In examples, the RAN database may be generated using past measurement reports from example WTRUs experiencing the problem and sending measurement reports. In examples, the network may pre-emptively configure a WTRU for sidelink activation, and the WTRU may trigger sidelink activation based on the received (pre-)configuration. In examples, the network may configure a WTRU for immediate sidelink activation.

As shown in FIG. 6, the network may generate trajectory predictions for example WTRUs (e.g., a first WTRU (WTRU_1) and a second WTRU (WTRU_2)) that may experience the coverage problem. The network may determine (e.g., a strategy for) how many predictions to trigger, how often to trigger predictions, when to trigger predictions, and for which WTRUs to trigger predictions. In examples, reporting of sub-optimal coverage in an area by a WTRU may trigger one or more predictions. As shown in FIG. 6, the network may predict that the first WTRU (WTRU_1) trajectory will intersect a sub-optimal coverage area (e.g., the area associated with satisfying the radio resource condition). The network may predict the second WTRU (WTRU_2) trajectory. Based on the predicted trajectory of the second WTRU (e.g., and the first WTRU), the network may determine that a proximity condition is satisfied (e.g., that the second WTRU may be located or may take a path that ensures the second WTRU is proximate to the first WTRU at a time the first WTRU is predicted to enter, be associated with the sub-optimal coverage area, or to remain in the sub-optimal coverage area).

As shown in FIG. 6, the network may select (e.g., via sending a sidelink activation indication to) WTRU_2—to activate sidelink functionality (e.g., within an activation window). The network may configure WTRU_2 and WTRU_1 to engage in sidelink communication (e.g., within the activation window). The network may send trajectory predictions to either or both WTRUs (e.g., the first WTRU (WTRU_1) and/or the second WTRU (WTRU_2). The first WTRU and/or the second WTRU may determine the activation window based on the received trajectory predictions. For example, the network may send the sidelink activation that includes trajectory information (e.g., the trajectory predictions).

In examples, the network trajectory predictions (e.g., for the first WTRU and the second WTRU) may be initial network trajectory predictions. The WTRU may return feedback on the (e.g., initial) network trajectory predictions (e.g., for the first WTRU and the second WTRU, based on its own trajectory predictions). The network may use any such feedback for various purposes (e.g. generating later trajectories, including predicting trajectories (e.g., modified trajectories) for the first WTRU and the second WTRU).

As shown in FIG. 6, WTRU_1 and WTRU_2 may engage in sidelink communication (e.g. acquire synchronization, exchange security credentials, etc.).

FIG. 7 is a path diagram including a timeline of events illustrating an example scenario involving including sidelink activation for coverage continuity. In examples, sidelink activation of a WTRU to provide coverage (e.g., additional coverage) may not be optimal. Example WTRUs that activate sidelink may (e.g., may also) be in mobility and coverage may not be sufficient to cover a sub-optimal coverage area. Example feature(s) associated with addressing such example scenarios are discussed. As shown in FIG. 7, a network may determine that a first WTRU will experience sub-optimal coverage (e.g., will enter or be close to a sub-optimal coverage area, for example, satisfying a radio resource condition as described herein) and may (e.g., based on the determination) activate a second WTRU for sidelink (e.g., to provide coverage to the first WTRU via sidelink). In examples (e.g., as shown in FIG. 7), sidelink activation of an example WTRU, such as WTRU_2 (e.g. from positions and/or times WTRU_2R to WTRU_2-R′, for example the activation window) may be based on a movement trajectory (e.g., predicted trajectory of WTRU_1 and/or WTRU_2). At some positions (e.g., WTRU_2-R′), the WTRU sidelink coverage area may intersect a sub-optimal coverage area of an example cell (e.g. cell1). At some positions (e.g., WTRU_2-R″), the WTRU sidelink coverage area may not intersect (e.g., may not be able to provide coverage to) the suboptimal coverage area.

As shown in FIG. 7, at 1, WTRU_2 at WTRU_2-R may activate sidelink communications to assist WTRU_1 (e.g. via a (pre-)configuration condition(s) being met or network configuration/command, as described herein). WTRU_2-R coverage illustrates an example coverage area corresponding to the sidelink at 1. At 2, WTRU_2-R may change position in time and/or space, and its coverage (WTRU_2-R′) may change in time and/or space and/or boundary. WTRU_2-R′ illustrates an example scenario in which the sidelink coverage area may be near a limit to useful coverage of the sub-optimal coverage area. In examples, trajectory prediction(s) may be used to determine a period of estimated sidelink suitability (e.g., in FIG. 7, a WTRU_2 R to R′ suitability window (e.g., activation window)). At 3, WTRU_2-R may move to position WTRU_2-R″ and its corresponding coverage area may change. At 3, WTRU_2-R″ coverage area may not intersect the sub-optimal coverage area and WTRU_2 sidelink service may be stopped (e.g., WTRU_2 sidelink service may be stopped based on a position of WTRU_2 satisfying a condition, such as being outside of coverage of the sub-optimal coverage area (or satisfying a condition associated with providing coverage to the sub-optimal coverage area).

As shown in FIG. 7, at 4 is shown an example span of time (WTRU_2 R to R′ suitability window (e.g., activation window)) during which WTRU_2 sidelink activation may be suitable (e.g., may be determined, signaled, and/or activated) to compensate for the suboptimal coverage area. In examples, the length of the span of time may be minimized. FIG. 7 illustrates a suitability window (e.g., activation window) as a span of time, but in other examples, a suitability window (e.g., activation window) may be determined by one or a combination of more than one of parameters such as: an indication of immediate trigger for sidelink broadcasting and/or trigger for sidelink de-activation; a time span start timestamp; a time span end timestamp; a time span duration; a geo-location area (e.g. a WTRU may lingers around an area, such lingering may be determined based on trajectory prediction); a distance from the sub-optimal coverage area; a measure of UP UL data received from a WTRU in sidelink; a measure of UP DL data sent to a WTRU in sidelink; etc. In examples, parameters may be configured via RRC.

In examples, a suitability window (e.g., activation window) definition may correspond to radio conditions. A network may predict that radio conditions of a WTRU candidate for sidelink activation fall within a range (e.g. a range that may be suitable for coverage provisioning to a WTRU encountering or predicted to encounter a sub-optimal coverage area, an area satisfying a radio resource condition area as described herein, etc.). For example, the network may predict RSRP of the WTRU sidelink candidate is capable to support service of a WTRU encountering or predicted to encounter the sub-optimal coverage area (e.g., determining the duration of suitability). In examples, the network may configure the WTRU sidelink candidate with radio related threshold(s), (e.g. which the WTRU sidelink candidate may use in determining a suitability window (e.g., activation window), for example, based on the radio quality falling below the radio related threshold(s), the WTRU sidelink candidate may activate sidelink communication). In examples, the WTRU sidelink candidate may be configured with one or more of: a single value for radio quality (e.g., RSRP, RSRQ, SINR, etc.) that may act as a threshold; a set of one or more values for radio quality (RSRP, RSRQ, SINR) that may act as one or more thresholds; combinations of threshold values (e.g. a minimum value for RSRP in combination with a maximum value of RSRQ); etc.

In examples, a candidate WTRU (e.g., second WTRU) for sidelink activation may be configured with information corresponding with support for another WTRU (e.g., first WTRU) which may experience sub-optimal coverage. For example, the candidate WTRU (e.g., second WTRU) may be configured with an identifier (e.g., the indication of an ID) associated with the other WTRU (e.g., the first WTRU). In examples, the network may configure one or more WTRUs of a set of candidate WTRUs with the identifier. In examples, the candidate WTRU (e.g., second WTRU) may receive one or more identifiers and may (e.g., may only) accept sidelink connections from WTRUs corresponding to one or more of identifiers.

In examples, there may not be a suitability window (e.g., activation window) during which a candidate WTRU (e.g., second WTRU) may be capable of providing sidelink coverage to serve a sub-optimal coverage area. For examples in which there may not be a candidate WTRU capable to assist an affected WTRU for the full time the affected WTRU may experience a coverage problem, a network may determine to configure more than one candidate WTRU (e.g. a set of WTRUs each with an associated activation window). Such set of activation windows may be sequential in time (e.g. one WTRU having a first window and a second WTRU having a second window configured to activate sidelink broadcast later than the first window activation). In examples, the network may generate windows in the set of windows to overlap in time sequentially (e.g. a first WTRU may activate sidelink coverage at a time corresponding to a second WTRU de-activating sidelink coverage). In such examples, sidelink resources may be available for a WTRU for a duration of its time in a suboptimal coverage area.

Example (pre-)configuration and triggering considerations for a candidate WTRU (e.g., second WTRU) for sidelink activation are provided herein. A candidate WTRU (e.g., second WTRU) may trigger sidelink activation autonomously (e.g., based on network-configured rules). A candidate WTRU (e.g., second WTRU) may trigger sidelink activation based on receiving a command, and in some examples may start broadcasting (e.g., immediately) based on the reception of the command.

A candidate WTRU (e.g., second WTRU) may provide (pre-)configuration feedback. In examples, the candidate WTRU (e.g., second WTRU) may receive one or more sidelink activation (pre-)configurations associated with network-predicted mobility of another WTRU (e.g., a first WTRU). In examples, the candidate WTRU (e.g., second WTRU) may be able to generate such predictions. In examples, the candidate WTRU (e.g., second WTRU) may provide feedback to the network associated with network prediction, based at least in part on WTRU predictions (e.g., the second WTRU may provide feedback to network predicted trajectory(ies) associated with the second WTRU and/or the first WTRU.

A WTRU may receive configuration information from the network. In examples, the configuration information may relate to compensation for suboptimal coverage (e.g., weak coverage areas, coverage holes, and the like). For example, such configuration information may include WTRU mobility prediction information, activation window information, one or more activation windows, and/or sub-optimal coverage area location information, etc. A WTRU may generate feedback based on received (pre-)configuration. In examples, the WTRU may provide such feedback to the network. In examples, the network may, based on the WTRU feedback, generate an updated configuration and may send the updated configuration to the WTRU. In examples, the network may incorporate WTRU feedback for a variety of purposes (e.g. to improve databases and/or to assess prediction model accuracy). In examples, WTRU feedback may include one or more of: time information including one or more of start timestamp, an end timestamp, or a duration; a geo-location area (e.g. associated with a WTRU lingering around an area as per trajectory predictions); a distance from the sub-optimal coverage area; an measure of UP UL data received from a connected WTRU; a measure of UP DL data sent to a connected WTRU; etc. In examples, such feedback measures may include direct measures and/or derived measures (e.g. rates, differences between predicted and observed values, etc.). Measures may be expressed at various granularities (e.g. per second, per millisecond, etc.). In examples, a measure may include a sign indicating relative time to a network (pre-)configuration. In examples involving network configured sub-optimal coverage area location information, the location information may be conveyed as a point location and/or as a geographical area. In examples, a WTRU may provide location information feedback in point and/or area form.

A WTRU (e.g., the second WTRU) may provide summary feedback following termination of sidelink activity (e.g., following the sidelink communication with the first WTRU within the activation window). Example summary feedback may include information associated with coverage assistance (e.g. the summary feedback may be connection-oriented and may include details that relate to the sidelink resource usage). In examples, WTRUs engaged in sidelink communication may exchange one or more sidelink measurement reports (e.g. for use in controlling a sidelink radio connection). In examples, summary feedback may include such sidelink measurement reports. In examples, summary feedback may include the radio quality associated with the sidelink communication (e.g., associated with the second WTRU communicating with the first WTRU within the activation window). The radio quality may be indicated by at least one of the following: a set of one or more WTRU RSRP measurements, RSRQ measurements, or SINR measurements (e.g., including measurements associated with one or more sidelink measurement reports); a subset of the measurement set based on a network configured threshold; a subset based on a network configured compound threshold condition (e.g., lower than threshold 1 and higher than threshold 2 or lower than threshold 1); a subset based on a network configured metric (e.g. linear average above or under a threshold, a moving average rate above or under a threshold, an immediate (e.g. between two consecutive points) change rate above or under a threshold, and/or other rate change metrics above or under a threshold); etc.

Examples related to the filtering of the report are provided herein. The WTRU may report metrics (e.g., all the metrics) determined during the activation window. The report may be filtered based on the threshold conditions being satisfied. The threshold conditions may be related to the sidelink channel or the WTRU-BS channel. This may be useful for the network to benchmark the sidelink performance compared with the performance the cell could have achieved.

A WTRU may receive and/or generate information related to traffic volume exchanged via sidelink (e.g. in accordance with network (pre-)configuration options). WTRU feedback may include one or more of: a measure of UP UL data received from a connected WTRU; a measure of UP DL data sent to a connected WTRU; a delta measure of UP UL data received from a connected WTRU (e.g. in relation to a networked configured amount); or a delta measure of UP DL data received by a connected WTRU (e.g. in relation to a networked configured amount). WTRU feedback may include information related to quality of service (QOS) and/or quality of experience (QoE). In examples, such information may be used to determine whether QoS requirements and/or targets have been satisfied via sidelink resources. QoS and/or QoE information may be expressed a various granularities (e.g., application level, flow level, stream level, sidelink link level).

A candidate WTRU may trigger sidelink activation, including based on network (pre-)configuration. The candidate WTRU may receive (pre-)configuration information from a network. In examples, the candidate WTRU may provide feedback information associated with activation conditions. The candidate WTRU may be configured to send feedback information (e.g. as discussed herein). The candidate WTRU may include feedback in WTRU-to-network messages (e.g. in measurement reports). WTRU feedback may be provided in one or more of: a form corresponding to network (pre-)configuration, a form including delta, or derived values. A candidate WTRU may base triggering on one or more configured thresholds and/or confidence values associated with WTRU prediction. For example, a WTRU may be configured with an activation window defined by three thresholds: a start time threshold, an end time threshold, and a confidence value threshold. In examples, the WTRU may, if predicting a start time, use a network configured start time as a baseline and a threshold for deviation from that value. In examples, the WTRU may (e.g., may then) predict a start time within the threshold (e.g. with a confidence value higher than the configured confidence threshold), and the WTRU may activate a broadcast of sidelink resources (e.g., based on the predicted start time).

In examples, a network may receive feedback information and/or reports from two WTRUs engaged in sidelink communication. Based on detecting mismatch between network predictions and received feedback information, the network may generate new sidelink (pre-)configuration and may provide the new sidelink (pre-)configuration to the WTRUS.

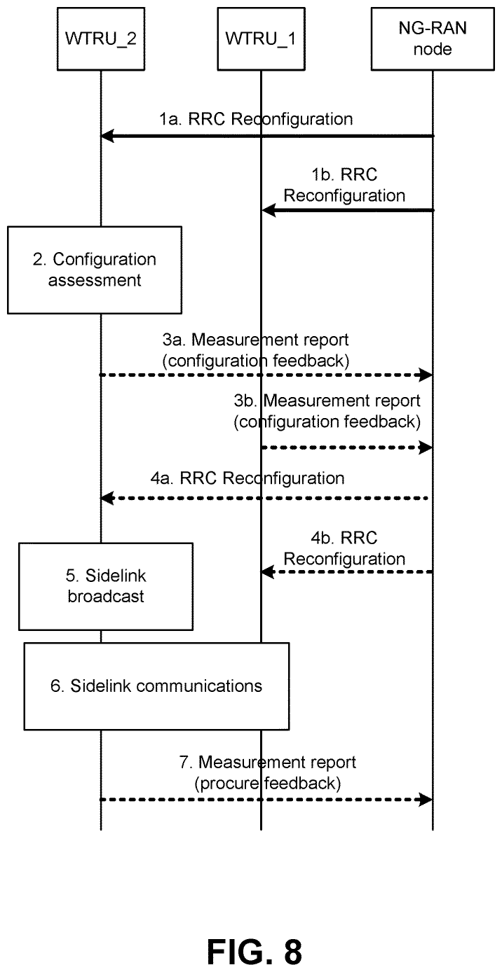

FIG. 8 illustrates an exemplary procedure for a (pre-)configuration, activation, and procedure of a WTRU providing sidelink coverage. At 1, a network may predict WTRU_1 will experience coverage problems. The network may predict that candidate WTRU_2 will be sufficient to provide assistance to WTRU_1 within a single activation window. At 1a, the network may send a sidelink (pre-)configuration (e.g., configuration information) and a feedback configuration to WTRU_2 (e.g. as an RRC Reconfiguration message). At 1b, WTRU_1 may receive the sidelink and feedback configurations (e.g. so that it may determine if to trigger sidelink communication with WTRU_2).

With continued reference to FIG. 8, at 2, WTRU_2 may perform inference based on the received (pre-)configurations and store any results (e.g. for later provision to the network). Inferences may be based on the sidelink (pre-)configuration and/or the feedback configuration (e.g., as discussed herein). At 3, WTRU_2 may provide feedback information to the network (e.g. via use measurement reporting messages or any other message to the network). At 4, the network may generate and provide sidelink and/or feedback re-configuration (e.g., including new configuration information and/or triggering conditions). The re-configuration may be based on the feedback information.

With continued reference to FIG. 8, at 5, WTRU_2 may activate sidelink broadcasting. At 6, WTRU_1 and WTRU_2 may engage in sidelink communication, and may generate and store feedback information (e.g., as discussed herein). At 7, sidelink communication may terminate. Either or both WTRU may send detailed feedback to the network related to the sidelink procedure (e.g., as discussed herein).

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-16. (canceled)

17. A second wireless transmit/receive unit (WTRU), comprising:
a processor configured to:
receive, from a network, a trajectory prediction of the second WTRU;
send, to the network, feedback associated with the trajectory prediction of the second WTRU;
receive, from the network, an indication to activate sidelink communication with a first WTRU within an activation window;
communicate with the first WTRU via a sidelink connection within the activation window; and
send, to the network, a feedback report associated with the sidelink communication with the first WTRU within the activation window.

18. The second WTRU of claim 17, wherein the processor is further configured to determine the activation window based on the feedback associated with the trajectory prediction of the second WTRU.

19. The second WTRU of claim 17, wherein the indication to activate sidelink communication with the first WTRU within the activation window comprises an indication of an identifier associated with the first WTRU.

20. The second WTRU of claim 17, wherein the feedback report indicates one of more of: a measurement associated with UL data received from a connected WTRU, a measurement associated with DL data sent to a connected WTRU, information related to quality of service, or information related to quality of experience.

21. The second WTRU of claim 17, wherein the feedback report indicates a radio quality associated with the sidelink communication with the first WTRU within the activation window.

22. The second WTRU of claim 21, wherein the radio quality is indicated by a reference signal received power (RSRP) value, a reference signal received quality (RSRQ) value, or a signal to noise and interference ratio (SINR) value.

23. The second WTRU of claim 17, wherein the activation window is a timing window defined by: starting and ending timestamps, or a geo-location area.

24. A method associated with a second wireless transmit/receive unit (WTRU), the method comprising:
receiving, from a network, a trajectory prediction of the second WTRU;
sending, to the network, feedback associated with the trajectory prediction of the second WTRU;
receiving, from the network, an indication to activate sidelink communication with a first WTRU within an activation window;
communicating with the first WTRU via a sidelink connection within the activation window; and
sending, to the network, a feedback report associated with the sidelink communication with the first WTRU within the activation window.

25. The method of claim 24, further comprising:
determining the activation window based on the feedback associated with the trajectory prediction of the second WTRU.

26. The method of claim 24, wherein the indication to activate sidelink communication with the first WTRU within the activation window comprises an indication of an identifier associated with the first WTRU.

27. The method of claim 24, wherein the feedback report indicates one of more of: a measurement associated with UL data received from a connected WTRU, a measurement associated with DL data sent to a connected WTRU, information related to quality of service, or information related to quality of experience.

28. The method of claim 24, wherein the feedback report indicates a radio quality associated with the sidelink communication with the first WTRU within the activation window.

29. The method of claim 28, wherein the radio quality is indicated by a reference signal received power (RSRP) value, a reference signal received quality (RSRQ) value, or a signal to noise and interference ratio (SINR) value.

30. The method of claim 24, wherein the activation window is a timing window defined by: starting and ending timestamps, or a geo-location area.
